(19) United States
(12) Patent Application Publication
(10) Pub. No.: US 2003/0166443 A1
(43) Pub. Date: Sep. 4, 2003

(54) Method of producing a package wrapper

(75) Inventor: Michael J. May, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/075,976

(22) Filed: Feb. 14, 2002

(51) Int. Cl. B31B 1/88

(52) U.S. Cl. 493/320

(57) ABSTRACT

A method of producing a package wrapper. The method comprises the steps of: displaying an image in a display area of an imaging device; providing a window which is movable relative to the image to produce a windowed image comprised of at least a portion of the image; providing a plurality of prestored patterns, each of the plurality of prestored patterns having at least one predetermined location wherein the windowed image may be placed; selecting one of the plurality of prestored patterns; combining the selected one of the plurality of prestored patterns and the windowed image to form a package wrapper, the windowed image being located at the at least one predetermined location; selecting a package wrapper size; and printing, displaying, transmitting, or storing the package wrapper.

### FIELD OF THE INVENTION

The present invention relates generally to the field of digital image processing. More particularly, the present invention relates to processing of digital information to produce a personalized/customized package wrapper.

### BACKGROUND OF THE INVENTION

Wrapping paper is a well known consumer product that can be purchased at many locations, including retail locations such as drug stores, grocery stores, and party supply stores. Consumers use wrapping paper to wrap packages. The wrapping paper includes a design/pattern such as a solid color, a geometric pattern, or a themed pattern for a particular holiday or occasion, for example, valentine's day or a birthday. Consumers particularly use wrapping paper to wrap gifts so as to create an aesthetically pleasing package. If using the wrapping paper to wrap a gift, the gift-giver (i.e., consumer) wants the wrapper paper to give an impression that the gift was selected and wrapped with thoughtfulness and care.

Manufacturers of wrapping paper produce quantities of a particular wrapping paper and distribute the wrapping paper for purchase by a consumer. Because of this manufacturing and distribution method, a consumer will often see a same pattern of wrapping paper at a plurality of stores. This may be beneficial for a consumer interested in purchasing wrapping paper. However, it may be undesirable if the retailer is trying to distinguish his store from another store by carrying “unique” wrapping paper that will draw consumers to his store.

In addition, because of this manufacturing and distribution method, manufacturers are more likely to manufacture wrapping paper with patterns acceptable to a wide audience, and therefore, may not manufacture wrapping paper with patterns directed to specialty groups or events. As such, consumers may not be able to find a wrapping paper having a pattern that fits the consumer's need, that is, a wrapper that is “just right” for the occasion/event or conveys a message of caring.

Still further, wrapping paper can be a bulky product, requiring significant amounts of shelf space for display. Accordingly, to stock wrapping paper with a variety of patterns so as to attract consumers, the retailer must devote a large amount of shelf space toward wrapping paper. This may be undesirable if shelf space is at a premium, as well as causing the retailer to invest in inventory.

Accordingly, a need continues to exist for a method of producing a wrapper that provides a retailer with an opportunity to offer a unique wrapper to consumers, not require the retailer to stock a large inventory of wrappers, not require the retailer to have large amounts of shelf space to display the wrapper, and provide a consumer with a wrapper that is “just right” for the occasion.

### SUMMARY OF THE INVENTION

An object of the present invention is to provide a method of producing wrapping paper that provides for personalization and customization.

Another object of the invention is to provide such a method which does not require a retailer/store to stock a large inventory of wrapping paper.

These objects are given only by way of illustrative example. Thus, other desirable objectives and advantages inherently achieved by the disclosed invention may occur or become apparent to those skilled in the art. The invention is defined by the appended claims.

According to one aspect of the invention, there is provided a method of producing a package wrapper. The method comprises the steps of displaying an image in a display area of an imaging device; providing a window which is movable relative to the image to produce a windowed image comprised of at least a portion of the image; displaying at least a portion of the package wrapper comprised of the windowed image; selecting a package wrapper size; and printing, displaying, transmitting, or storing the package wrapper.

According to another aspect of the invention, there is provided a method of producing a package wrapper. The method comprises the steps of providing an imaging device having a display for displaying an image provided by a user; providing a window which is movable relative to the image to produce a windowed image comprised of a portion of the image; forming at least a portion of a package wrapper comprising the windowed image; displaying the at least a portion of the package wrapper comprised of the windowed image; selecting a package wrapper size; and printing, displaying, transmitting, or storing the package wrapper at the selected package wrapper size.

According to a further aspect of the invention, there is provided a method of producing a package wrapper. The method comprises the steps of displaying an image in a display area of an imaging device; providing a window which is movable relative to the image to produce a windowed image comprised of at least a portion of the image; providing a plurality of prestored patterns, each of the plurality of prestored patterns having at least one predetermined location wherein the windowed image may be placed; selecting one of the plurality of prestored patterns; combining the selected one of the plurality of prestored patterns and the windowed image to form a package wrapper, the windowed image being located at the at least one predetermined location; selecting a package wrapper size; and printing, displaying, transmitting, or storing the package wrapper.

According to still another aspect of the invention, there is provided a method of producing a package wrapper at a retail location. The method comprises the steps of providing an imaging device located at the retail location, the imaging device having a printer and a display area; displaying a user-supplied image in the display area; selecting one of a plurality of prestored patterns, each of the plurality of prestored patterns having at least one predetermined location wherein at least a portion of the user-supplied image may be placed; combining the selected one of the plurality of prestored patterns and the at least a portion of the user-supplied image to form a package wrapper, the at least a portion of the user-supplied image being located at the at least one predetermined location; selecting a package wrapper size; and printing the package wrapper at the retail location

According to yet still another aspect of the invention, there is provided a method of producing a package wrapper. The method comprises the steps of displaying an image in a display area of an imaging device; providing a window which is movable relative to the image to produce a windowed image comprised of at least a portion of the image; providing a plurality of prestored patterns, each of the plurality of prestored patterns having at least one predetermined location wherein the windowed image may be placed; selecting one of the plurality of prestored patterns; combining the selected one of the plurality of prestored patterns and the windowed image to form a package wrapper, the windowed image being located at the at least one predetermined location; selecting a package wrapper size; transmitting the package wrapper to a remote location; and printing the package wrapper at the remote location at the selected package wrapper size.

The present invention provides a method of producing a wrapper that is personalized or customized, and does not require a large inventory to be carried by a retailer.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 generally illustrates an imaging device formed as a kiosk which is suitable for producing a package wrapper in accordance with the present invention.

FIG. 2 generally shows a diagram of included functions of the imaging device of FIG. 1.

FIG. 3 shows a flow diagram of a first method of producing a package wrapper in accordance with the present invention.

FIG. 4 shows a display displaying a digital image.

FIG. 5 shows the display of FIG. 4 further showing a movable window.

FIG. 6 shows a windowed image formed by moving the window in the display of FIG. 5.

FIG. 7 shows a portion of a package wrapper formed using the windowed image of FIG. 6.

FIG. 8 shows a representation of a package wrapped with the package wrapper of FIG. 7.

FIG. 9 shows a prestored pattern comprising a plurality of determined locations wherein the windowed image may be placed.

FIG. 10 shows the prestored pattern of FIG. 9 wherein the windowed image of FIG. 6 has been placed in the predetermined locations.

FIG. 11 shows a flow diagram of a second method of producing a package wrapper in accordance with the present invention wherein a plurality of prestored patterns are provided.

FIG. 12 shows a display comprising a plurality of prestored patterns.

FIG. 13 shows a customized prestored pattern.

FIG. 14 shows a package wrapper comprising a bow.

### DETAILED DESCRIPTION OF THE INVENTION

The following is a detailed description of the preferred embodiments of the invention, reference being made to the drawings in which the same reference numerals identify the same elements of structure in each of the several figures.

It is understood that the terms “wrapping paper”, “package wrapper”, and “wrapper” are used interchangeably to describe a material (typically a sheet material) used to cover and enclose the object so as to generate a wrapped object. Other commonly used terms for wrapping paper may be known.

The present invention provides a method of producing a package wrapper using an image provided by a consumer/user. Accordingly, a personalized package wrapper is produced. As will become evident from the description of the present invention, the personalized package wrapper can be produced on-demand using an imaging device at a retail location.

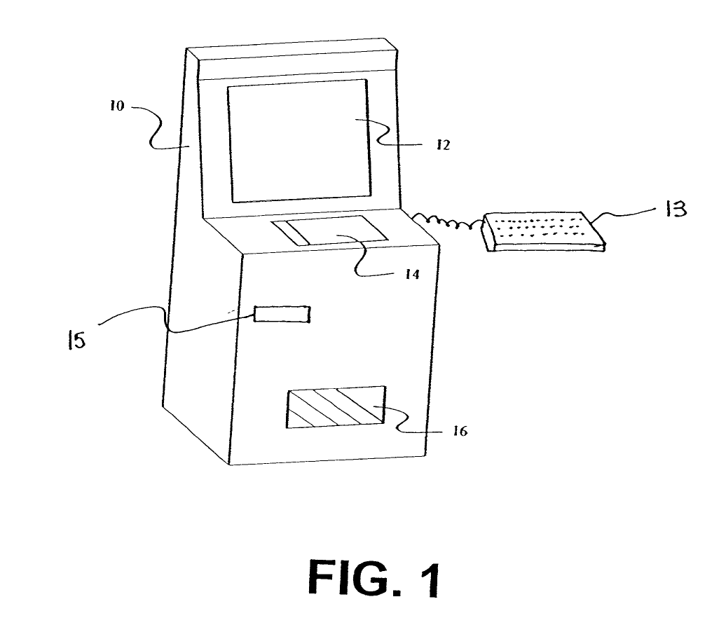

An example of an imaging device suitable for producing the package wrapper in accordance with the present invention is a kiosk. An example of a kiosk is a Picture Maker™ kiosk produced by Eastman Kodak Company. Other examples of kiosks are known to those skilled in the art. Imaging device 10 is generally illustrated in FIG. 1. Imaging device 10 includes a color display 12 for displaying information or an image, for example, the pattern for the package wrapper or the image used to form a pattern for the package wrapper. Color display 12 can be a touchscreen display, whereby a user can input information and data to imaging device 10, or a keyboard 13 may be used to provide information and data. A scanner 14 may be provided for receiving a user-supplied visual image (such as a photograph) and converting the visual image into digital form. Alternatively, an input port 15 may be provided for receiving the user-supplied image in digital form, such as from a memory card, floppy disk, compact disc, or PictureCD. Imaging device 10 further includes a delivery section 16 for controlling the delivery of the package wrapper. Delivery section 16 is illustrated in FIG. 1 as an opening in imaging device 10.

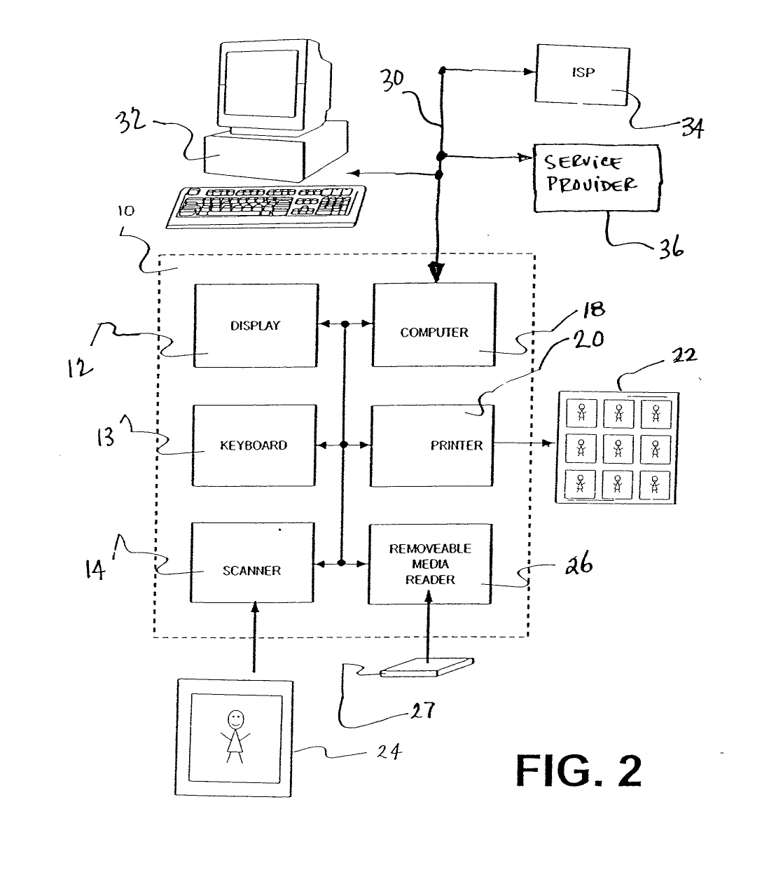

FIG. 2 generally shows a diagram of included functions of imaging device 10. As illustrated, imaging device 10 may include keyboard 13 for entering information/data into a computer/processor 18. Computer 18 typically manages the flow of information and functionality of the components of imaging device 10. Imaging device 10 includes an output producing device 20, such as printer, for producing a package wrapper. Printer 20 responds to commands of computer 18 for forming a package wrapper.

Typically, a package wrapper is provided in sheet form and is comprised of a medium which is substantially flexible/bendable so as to be able to overlap/cover a package. Examples of a possible media include paper, thermal paper, ink-jet paper, plastic, polyethylene, textured material, cloth-based or fabric-based material, or any combination thereof. An example of a sheet of a package wrapper is illustrated in FIG. 2 at 22 which was formed from a user-supplied image 24.

A removable media reader 26 can be used to receive user-supplied image 24 from a removable media 27, for example, a memory card, floppy disk, compact disc, PictureCD, or other form of removable media used in transferring digital files and digital data.

Imaging device 10 can communicate with other systems by means of a communication network 30. For example, imaging device 10 may communicate with a home computer system, generally designated at 32, an Internet Service Provider (ISP) 34, or service provider 36 providing imaging products or having printers, for example, a wholesale photofinishing lab. Such a communication network 30 allows a consumer/user to upload and/or download an image for the creation of a package wrapper in accordance with the present invention.

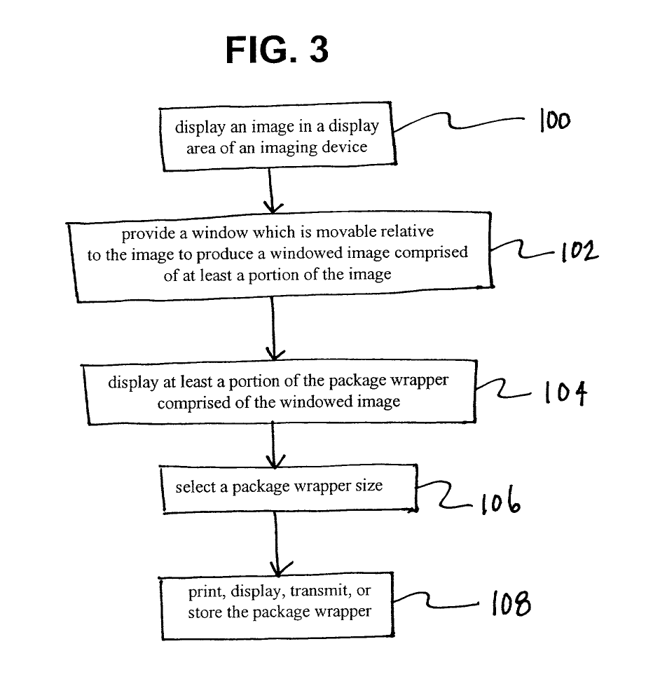

FIG. 3 shows a flow diagram of a first method in accordance with the present invention for producing a package wrapper. An image is provided by a user to imaging device 10, for example, using scanner 14 to digitize a visual image or using input port 15 to receive a user-supplied image in digital form. The digital image is displayed in a display area of an imaging device (step 100). A window is provided in the display which is movable relative to the image to produce a windowed image comprised of at least a portion of the image (step 102). Then, at least a portion of the package wrapper comprised of the windowed image is displayed (step 104). Once a package wrapper size has been selected (step 106), the package wrapper can be printed, displayed, transmitted, or stored (step 108).

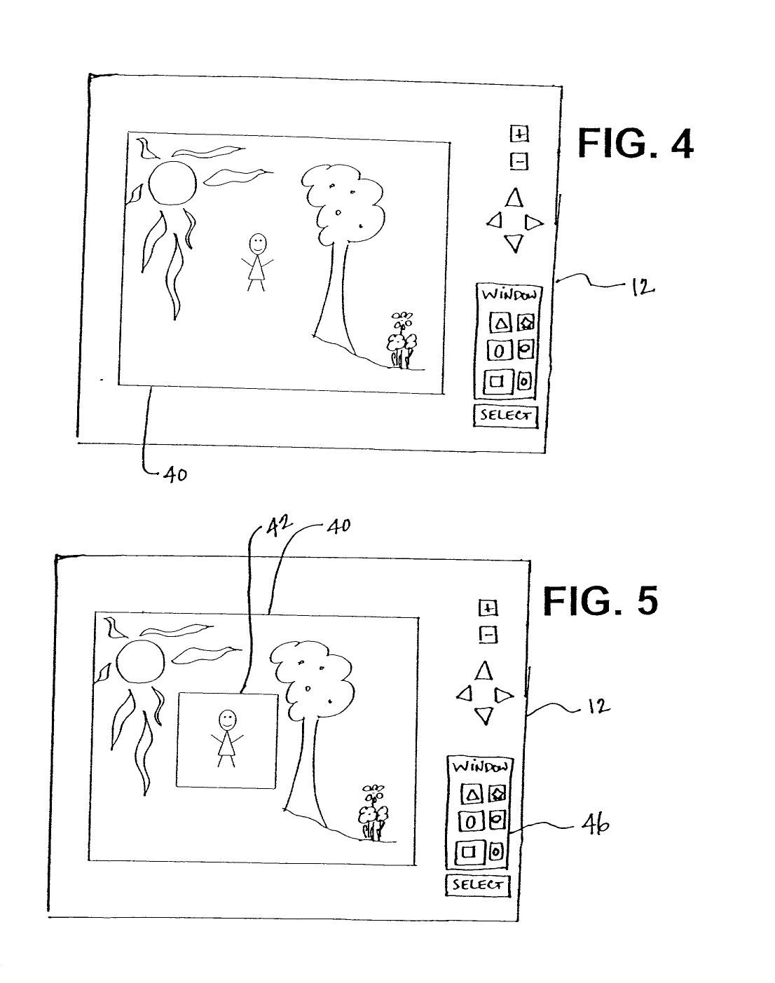

FIGS. 4 through 7 more particularly illustrate the method shown in FIG. 3. A digital image 40 of a user-supplied image is displayed in a display area of display 12. As illustrated, digital image 40 comprises several elements, including a person, a tree, a sun, and some flowers.

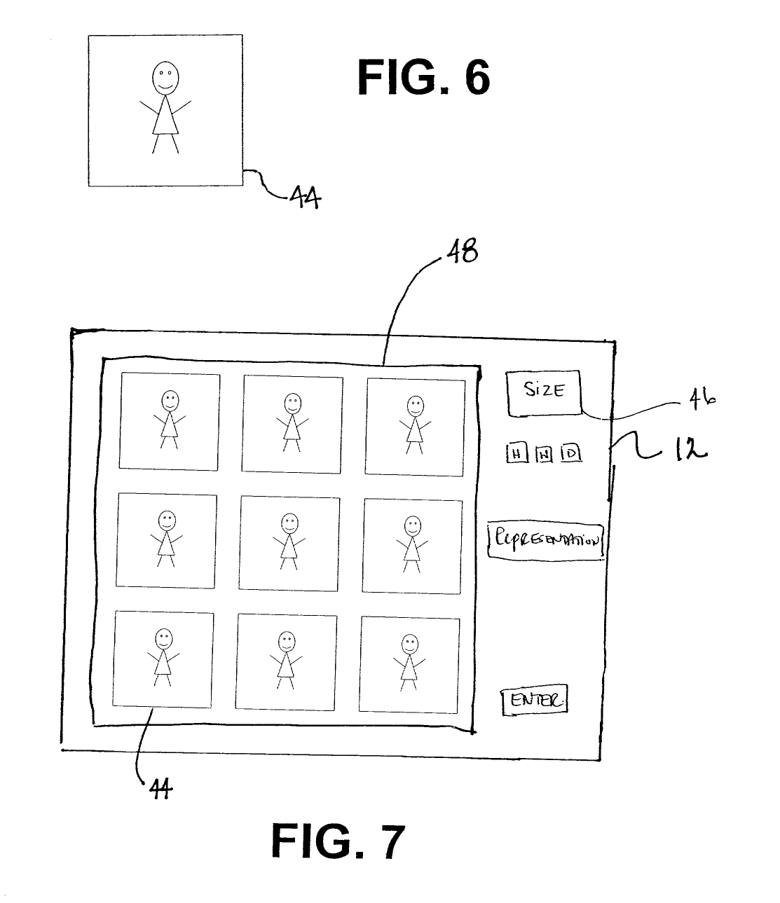

A window 42 is provided in display 12, with window 42 being movable relative to image 40 to produce a windowed image 44 comprised of at least a portion of image 40. As best illustrated in FIGS. 5 and 6, window 42 is moved relative to image 40 to frame the person to produce windowed image 44.

Selection means 46 displayed on display 12 (or alternatively, available using keyboard 13, a touchscreen, or other input means of imaging device 10) may be employed to assist in moving window 42 and/or shaping or sizing window 42 so that the user can form a desired windowed image. For example, as illustrated in FIG. 5, selection means 46 includes a “+” and “−” key to increase/decrease, respectively, the size of window 42, and also includes “shape” keys (i.e., circle, oval, square, star, triangle) to shape window 42.

FIG. 7 illustrates a portion of the package wrapper 48 comprised of the windowed image 44 displayed in display 12 (i.e., step 104).

Selection means 46 can be used to select a package wrapper size (step 106). For example, as illustrated in FIG. 7, a “size” key may be activated to enter a numerical square foot value (i.e., 100 square feet or 10 foot×10 foot). Alternatively, the dimensions of the package may be provided. For example, the height, width, and depth dimensions, wherein imaging device 10 can automatically determine the package wrapper size needed to cover the package. Still further, printer 20 may be configured to print a package wrapper of a predetermined size, that is, printer 20 may be limited to several standard sizes. If printer 20 is configured to print only one size package wrapper, it may be necessary to obtain more than on package wrapper to ensure the covering of a large package. Yet further, a consumer may desire to select a larger output than is immediately required so as to have extra wrapping for an additional gift or a further gift not yet purchased. Still yet further, a consumer may desire to select a large output so as to have sufficient quantity to wrap multiple packages with the same design wrapper. If printer 20 is configured to provide images/printing on two sides of a sheet of the package wrapper, the package wrapper can have images on both side of the sheet.

Once the user has selected the desired size/pattern, the system will “tile” the image to create the package wrapper. That is, the system will reproduce the windowed image or pattern to create the package wrapper at the selected package wrapper size. As part of this tiling process, the user may select options such as spacing between the images, and artwork to fill the inter-image space. The user may also select the angle that the image is tiled across the package wrapper.

The user may also select to have the selected package wrapper displayed on only one specified side of the package (assuming package dimensions were entered). The system “stretches” the image (maintaining appropriate aspect ratios if desired) to fill the side of the package. The other sides of the package could then employ a selected background pattern.

Additionally, printer 20 may be configured to provide a sample of the package wrapper to the user. Such a sample may be desired prior to printing, storing, or transmitting. The sample is intended to be of a small size to provide the user with a representation of the package wrapper.

The package wrapper can then be printed and provided to the user via delivery area 16. Alternatively, the package wrapper can be displayed in display 12, transmitted to another system/device using communication network 30, or stored to a removable media using input port 15.

Still further, image 40 and/or windowed image 44 can be printed, displayed, transmitted, or stored.

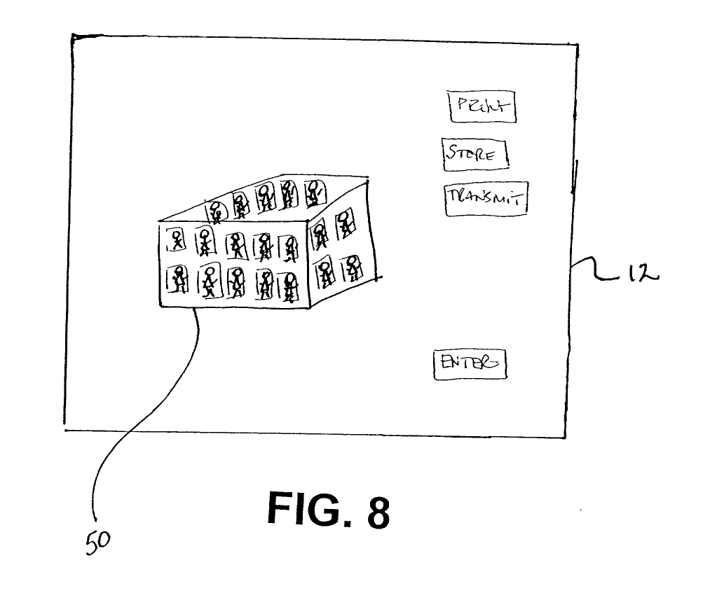

Yet further, a representation (i.e., an illustration) of the package wrapped in the selected package wrapper can be displayed in display 12 to provide the user with a visual image of the package wrapped in the selected package wrapper. FIG. 8 provides a representation 50 of a box wrapped in the package wrapper shown in FIG. 7. From the visual representation, the user can determine if the selected/proposed package wrapper provides an aesthetically pleasing package. For example, the user may determine that the windowed image is too large for the package wrapper size, or that text size is not pleasing.

Once windowed image 44 is produced, windowed image 44 may be arranged in a plurality of patterns to produce the package wrapper. Accordingly, a plurality of prestored patterns may be presented to the user for selection. Each prestored pattern would include at least one predetermined location wherein windowed image 44 may be placed. Once the user selects one of the plurality of prestored patterns, the selected prestored pattern and the windowed image would be combined to form a package wrapper, with the windowed image being located at the predetermined location.

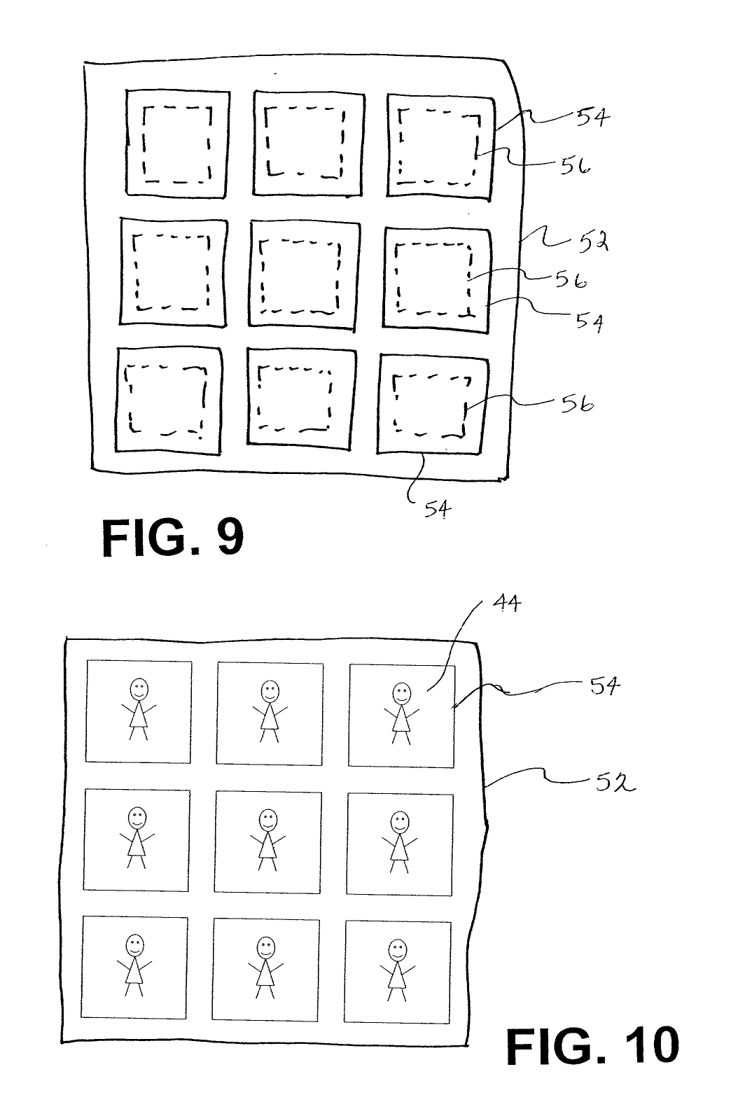

For example, a section 52 of a package wrapper is shown in FIG. 9 as having a checked pattern comprised of a plurality of pattern areas 54. Each pattern area 54 includes a predetermined location 56 wherein windowed image 44 may be placed. In FIG. 10, windowed image 44 (best shown in FIG. 6) has been placed in each predetermined location 56 of section 52 to produce a portion of a package wrapper.

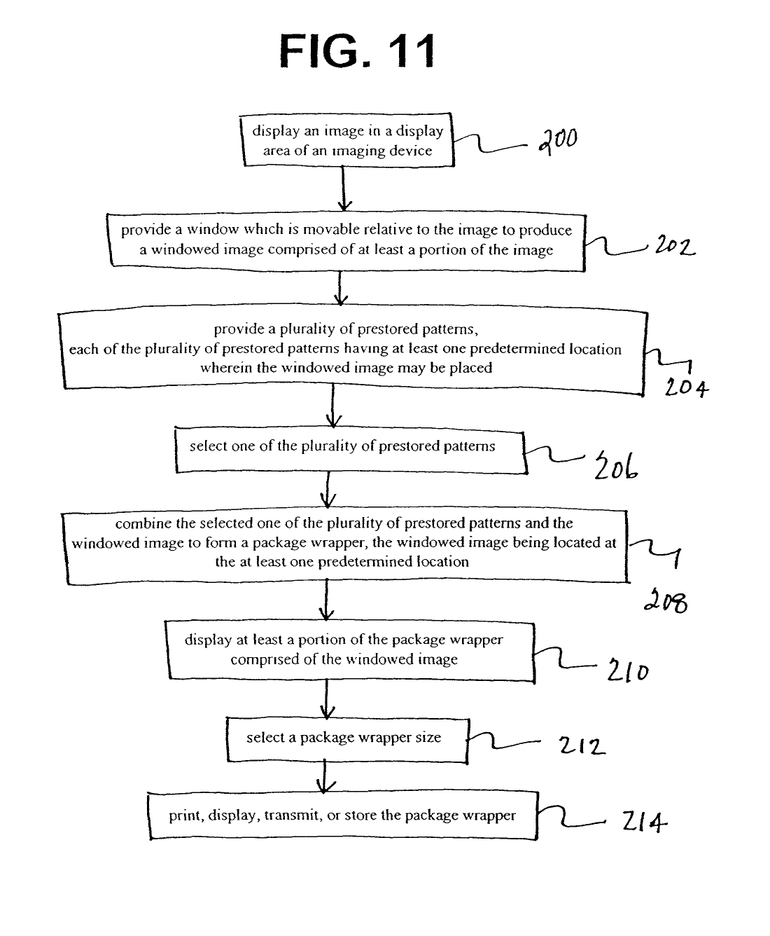

FIG. 11 shows a flow diagram of a second method in accordance with the present invention for producing a package wrapper wherein a plurality of prestored patterns are displayed for a user's perusal and selection. An image is provided by a user to imaging device 10, for example, using scanner 14 to digitize a visual image or using input port 15 to receive a user-supplied image in digital form. The digital image is displayed in a display area of an imaging device (step 200). A window is provided in the display which is movable relative to the image to produce a windowed image comprised of at least a portion of the image (step 202). A plurality of prestored patterns is provided, wherein each of the plurality of prestored patterns comprises at least one predetermined location wherein the windowed image may be placed (step 204). The user selects one of the plurality of prestored patterns (step 206). Once a prestored pattern is selected, the selected prestored pattern and the windowed image are combined to form a package wrapper, wherein the windowed image being located at the at least one predetermined location (step 208). Optionally, at least a portion of the package wrapper comprised of the windowed image can be displayed (step 210). Once a package wrapper size has been selected (step 212), the package wrapper can be printed, displayed, transmitted, or stored (step 214).

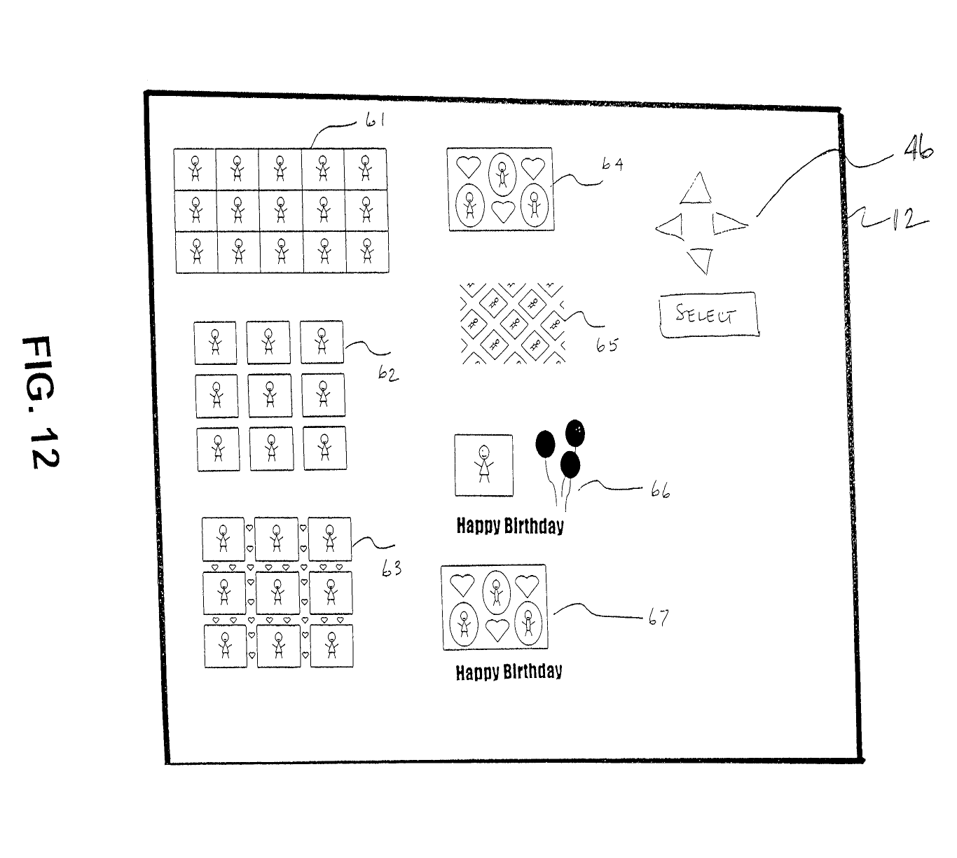

FIG. 12 more particularly illustrates the method shown in FIG. 11. More particularly, FIG. 12 shows display 12 comprising a plurality of prestored patterns. As illustrated in FIG. 9, display 12 displays a plurality of prestored patterns 61-67. Prestored pattern 61 comprises a plurality of pattern areas uniformly arranged. Prestored pattern 62 comprises a plurality of pattern areas spaced from each other. Prestored pattern 63 comprises a plurality of pattern areas spaced from each other to form interstices, and heart shaped icons are disposed in the interstices.

Each of the prestored patterns includes at least one predetermined location wherein windowed image may be placed. For example, prestored pattern 61 includes a plurality of predetermined locations, whereas prestored pattern 66 includes only one predetermined location. Other patterns will be known to those skilled in the art, for example, a kaleidoscope pattern or random pattern may be desired.

Selection means 46 may be used by the user to select/indicate the desired pattern. Such selection/indication can also be accomplished by a touchscreen, keyboard, or other known selection means.

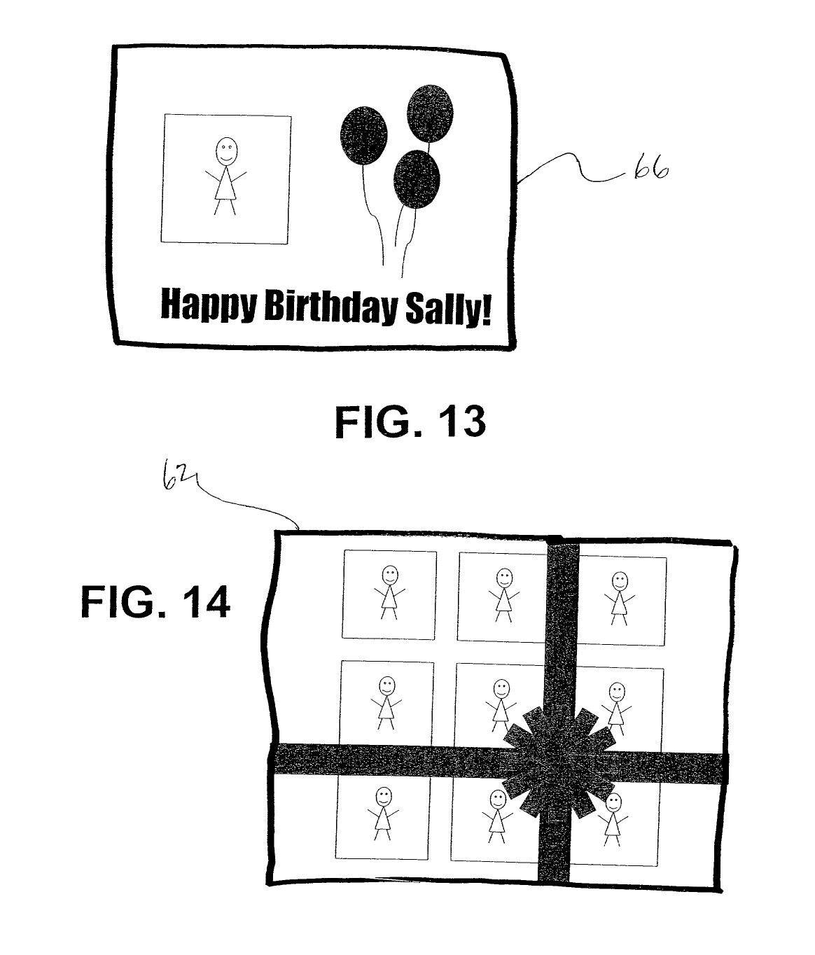

The user may desire to create a personalized pattern, or the user may desire to customize the prestored patterns. For example, the user may desire to include textual information, graphics, or iconic information to a prestored pattern. Accordingly, imaging device 10 may be configured so that the user may customize the prestored patterns. FIG. 13 shows prestored pattern 66 comprising a customized birthday greeting of “Happy Birthday Sally”. Other personalized information may be combined with the windowed image or prestored pattern. Such personalized information can include messages, greetings, retail store information, advertising, and font/color/size.

In addition, a plurality of predefined images may be provided for inclusion with the prestored pattern. Examples of predefined images include a cartoon character, background, border, bow, ribbon, predefined text, and/or clip art. Accordingly, the user would select at least one predefined image from a plurality of predefined images, and the selected predefined image would be merged with the windowed image. For example, FIG. 14 shows prestored pattern 62 including a predefined image of a bow. The inclusion of such predefined images can provide customization of a package wrapper and can be configured for a particular package size.

In addition, particular prestored holiday patterns may be available during a holiday season. For example, during the first two weeks of February, special “valentine” patterns may be available for the Valentine's Day holiday. Such holiday patterns may be stored in software in imaging device 10 and activated upon the reaching of a predetermined date in the imaging device's “calendar clock” (e.g., February 1), and then deactivated after reaching another predetermined date (e.g., February 15).

The personalization and customization can be accomplished using methods known to those skilled in the art, for example, using keyboard 13 or a touchscreen.

The method of the present invention is suited for employment at a retail location. Yet, dependent on the desired size of the package wrapper and the configuration of the printer, the method of the present invention can be employed in a home environment using a home computer. However, if large sheets of a package wrapper are desired, a large format printer may be required which may not be suitable for home use. As such, the package wrapper can be transmitted to a remote location, and the printing the package wrapper can be accomplished at the remote location (which may or may not be a retail location) at the selected package wrapper size. The package wrapper can be mailed to the user, or the user can pick up the package wrapper at the remote location or retail location. Examples of retail locations are mass, food, or drug stores.

If large sheets of a package wrapper are desired, delivery section 16, as illustrated in FIG. 1, may not be of a sufficient size to deliver the package wrapper to the consumer. Accordingly, it is understood that printer 20 may be external to imaging device 10. For example, printer 20 may be proximate imaging device 10 or available through communication network 30. As such, imaging device 10 might not comprise delivery section 16.

It should be noted that if the package wrapper is to be transmitted or stored for later access, the package wrapper does not need to be transmitted or stored at the selected package wrapper size. Rather, a portion of the package wrapper may be transmitted or stored, for example, the windowed image. Alternatively, sizing information can be transmitted or stored so that the package wrapper can be recreated.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

Accordingly, the present invention provides a method of producing a unique package wrapper for a consumer. The method does not require a retailer to stock a large inventory of wrappers, nor does the method require the retailer to have large amounts of shelf space to display the wrapper

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

PARTS LIST

| | |
|---|---|
| 10 | imaging device |
| 12 | display |
| 13 | keyboard |
| 14 | scanner |
| 15 | input port |
| 16 | delivery section |
| 18 | computer; processor |
| 20 | output producing device; printer |
| 22 | sheet of wrapping paper |
| 24 | user-supplied image |
| 26 | removable media reader |
| 27 | removable media |
| 30 | communications network |
| 32 | home computer system |
| 34 | Internet Service Provider (ISP) |
| 36 | service provider |
| 40 | digital image |
| 42 | window |
| 44 | windowed image |
| 46 | selection means |
| 48 | portion of package wrapper |
| 50 | representation |
| 52 | section of a package wrapper |
| 54 | pattern area |
| 56 | predetermined location |
| 61-67 | prestored patterns |

What is claimed is:

1. A method of producing a package wrapper, comprising the steps of:
displaying an image in a display area of an imaging device;
providing a window which is movable relative to the image to produce a windowed image comprised of at least a portion of the image;
displaying at least a portion of the package wrapper comprised of the windowed image;
selecting a package wrapper size; and
printing, displaying, transmitting, or storing the package wrapper.

2. The method of claim 1, further comprising the step of printing, displaying, transmitting, or storing the package wrapper in accordance with the selected package wrapper size.

3. The method of claim 1, further comprising the step of printing, displaying, transmitting, or storing the windowed image.

4. The method of claim 1, further comprising the step of printing, displaying, transmitting, or storing the image.

5. The method of claim 1, wherein the step of selecting the package wrapper size is accomplished by inputting the dimensions of a package.

6. The method of claim 1, further comprising the steps of:
selecting at least one predefined image from a plurality of predefined images, and
combining the selected at least one predefined image with the windowed image.

7. The method of claim 1, further comprising the step of combining personalized information with the windowed image.

8. A method of producing a package wrapper, comprising the steps of:
providing an imaging device having a display for displaying an image provided by a user;
providing a window which is movable relative to the image to produce a windowed image comprised of a portion of the image;
forming at least a portion of a package wrapper comprising the windowed image;
displaying the at least a portion of the package wrapper comprised of the windowed image;
selecting a package wrapper size; and
printing, displaying, transmitting, or storing the package wrapper at the selected package wrapper size.

9. A method of producing a package wrapper, comprising the steps of:
displaying an image in a display area of an imaging device;
providing a window which is movable relative to the image to produce a windowed image comprised of at least a portion of the image;
providing a plurality of prestored patterns, each of the plurality of prestored patterns having at least one predetermined location wherein the windowed image may be placed;
selecting one of the plurality of prestored patterns;
combining the selected one of the plurality of prestored patterns and the windowed image to form a package wrapper, the windowed image being located at the at least one predetermined location;
selecting a package wrapper size; and
printing, displaying, transmitting, or storing the package wrapper.

10. The method of claim 9, further comprising the step of display at least a portion of the package wrapper comprised of the windowed image.

11. The method of claim 9, wherein each of the plurality of prestored patterns includes a plurality of predetermined locations wherein the windowed image may be placed; and the package wrapper is formed by combining the selected one of the plurality of prestored patterns and the windowed image, the windowed image being located at each of the plurality of predetermined locations.

12. The method of claim 9, further comprising the step of printing, displaying, transmitting, or storing the package wrapper at the selected package wrapper size.

13. The method of claim 9, further comprising the step of printing, displaying, transmitting, or storing the windowed image.

14. The method of claim 9, further comprising the step of printing, displaying, transmitting, or storing the image.

15. The method of claim 9, wherein the step of selecting the package wrapper size is accomplished by inputting the dimensions of a package.

16. The method of claim 9, further comprising the steps of:
selecting at least one predefined image from a plurality of predefined images; and
combining the selected at least one predefined image with the selected one of the plurality of prestored patterns and the windowed image to form the package wrapper.

17. The method of claim 9, further comprising the step of combining personalized information with the selected one of the plurality of prestored patterns and the windowed image to form the package wrapper.

18. The method of claim 9, wherein at least one of the prestored patterns comprises a plurality of pattern areas uniformly arranged.

19. The method of claim 9, wherein at least one of the prestored patterns comprises a plurality of pattern areas spaced from each other.

20. The method of claim 9, wherein at least one of the prestored patterns comprises a plurality of pattern areas spaced from each other to form interstices, and predefined information is disposed in the interstices.

21. A method of producing a package wrapper at a retail location, comprising the steps of:
providing an imaging device located at the retail location, the imaging device having a printer and a display area;
displaying a user-supplied image in the display area;
selecting one of a plurality of prestored patterns, each of the plurality of prestored patterns having at least one predetermined location wherein at least a portion of the user-supplied image may be placed;
combining the selected one of the plurality of prestored patterns and the at least a portion of the user-supplied image to form a package wrapper, the at least a portion of the user-supplied image being located at the at least one predetermined location;
selecting a package wrapper size; and
printing the package wrapper at the retail location

22. A method of producing a package wrapper, comprising the steps of:
displaying an image in a display area of an imaging device;
providing a window which is movable relative to the image to produce a windowed image comprised of at least a portion of the image;
providing a plurality of prestored patterns, each of the plurality of prestored patterns having at least one predetermined location wherein the windowed image may be placed;
selecting one of the plurality of prestored patterns;
combining the selected one of the plurality of prestored patterns and the windowed image to form a package wrapper, the windowed image being located at the at least one predetermined location;
selecting a package wrapper size;
transmitting the package wrapper to a remote location; and
printing the package wrapper at the remote location at the selected package wrapper size.

23. A computer storage product having at least one computer storage medium having instructions stored therein causing one or more computers to perform the method of claim 1.

24. A package wrapper produced by the method of claim 1.

25. A package wrapper produced by the method of claim 9.
